(19) United States
(12) Patent Application Publication
(10) Pub. No.: US 2025/0151065 A1
(43) Pub. Date: May 8, 2025

(54) DEVICES, METHODS, APPARATUSES, AND COMPUTER READABLE MEDIA FOR UPLINK TRANSMISSION DURATION EXTENSION

(71) Applicant: Nokia Technologies Oy, Espoo (FI)

(72) Inventors: Mads LAURIDSEN, Aalborg (DK); Ping YUAN, Beijing (CN); Jing Yuan SUN, Beijing (CN)

(21) Appl. No.: 18/933,526

(22) Filed: Oct. 31, 2024

(30) Foreign Application Priority Data
Nov. 3, 2023 (WO) PCT/CN2023/129751

(51) Int. Cl. H04W 72/21; H04W 56/00

(52) U.S. Cl. CPC H04W 72/21; H04W 56/001

(57) ABSTRACT

An example apparatus for a terminal device may include at least one processor and at least one memory storing instructions that, when executed, may cause the terminal device at least to: receive from a network device, at least one first indication indicating whether allowing the terminal device to extend an uplink transmission duration, during which uplink transmission is allowed, after expiry of a position validity duration; and perform one of the following: extending the uplink transmission duration according to the at least one first indication until receiving from the network device a second indication indicating the terminal device to stop the uplink transmission duration, or extending the uplink transmission duration according to each of received multiple first indications and stopping the uplink transmission duration when the uplink transmission duration extended according to said each of the first indications expires.

### TECHNICAL FIELD

Various example embodiments relate to devices, methods, apparatuses, and computer readable media for uplink transmission duration extension.

### BACKGROUND

Position measurement, for example, global navigation satellite system (GNSS) measurement is necessary for a user equipment (UE) in a non-terrestrial network (NTN) to perform pre-compensation of uplink transmission in terms of time and frequency adjustments. In the NTN, the network side can trigger the UE to perform the GNSS measurement, e.g. when the current GNSS validity duration is about to expire, and the UE can also autonomously trigger the GNSS measurement if the UE does not receive the trigger from the network side. In the NTN, the UE is not able to communicate with the network side and perform the GNSS measurement simultaneously. When the UE has to perform the GNSS measurement, the UE will move to radio resource control (RRC) idle mode. However, moving to the RRC idle mode creates overhead in terms of connection setup signaling if the UE has a long connection and is non-stationary.

### SUMMARY

A brief summary of exemplary embodiments is provided below to provide basic understanding of some aspects of various embodiments. It should be noted that this summary is not intended to identify key features of essential elements or define scopes of the embodiments, and its sole purpose is to introduce some concepts in a simplified form as a preamble for a more detailed description provided below.

In a first aspect, disclosed is an apparatus for a terminal device. The apparatus may include at least one processor and at least one memory. The at least one memory may store instructions that, when executed by the at least one processor, may cause the terminal device at least to: receive from a network device, at least one first indication indicating whether allowing the terminal device to extend an uplink transmission duration, during which uplink transmission is allowed, after expiry of a position validity duration; and perform one of the following: extending the uplink transmission duration according to the at least one first indication if the at least one first indication allows the terminal device to extend the uplink transmission duration, until receiving from the network device a second indication indicating the terminal device to stop the uplink transmission duration, or extending the uplink transmission duration according to each of received multiple first indications if said each of the received multiple first indications allows the terminal device to extend the uplink transmission duration, and stopping the uplink transmission duration when the uplink transmission duration extended according to said each of the first indications expires.

In a second aspect, disclosed is an apparatus for a network device. The apparatus may include at least one processor and at least one memory. The at least one memory may store instructions that, when executed by the at least one processor, may cause the network device at least to: transmit to a terminal device, at least one first indication indicating whether allowing the terminal device to extend an uplink transmission duration, during which uplink transmission is allowed, after expiry of a position validity duration, wherein the terminal device is allowed to extend the uplink transmission duration according to the at least one first indication if the at least one first indication allows the terminal device to extend the uplink transmission duration, until receiving from the network device a second indication indicating the terminal device to stop the uplink transmission duration, or the terminal device is allowed to extend the uplink transmission duration according to each of received multiple first indications if said each of the received multiple first indications allows the terminal device to extend the uplink transmission duration and is required to stop the uplink transmission duration when the uplink transmission duration extended according to said each of the first indications expires.

In a third aspect, disclosed is a method performed by an apparatus for a terminal device. The method may comprise: receiving from a network device, at least one first indication indicating whether allowing the terminal device to extend an uplink transmission duration, during which uplink transmission is allowed, after expiry of a position validity duration; and performing one of the following: extending the uplink transmission duration according to the at least one first indication if the at least one first indication allows the terminal device to extend the uplink transmission duration, until receiving from the network device a second indication indicating the terminal device to stop the uplink transmission duration, or extending the uplink transmission duration according to each of received multiple first indications if said each of the received multiple first indications allows the terminal device to extend the uplink transmission duration, and stopping the uplink transmission duration when the uplink transmission duration extended according to said each of the first indications expires.

In a fourth aspect, disclosed is a method performed by an apparatus for a network device. The method may comprise: transmitting to a terminal device, at least one first indication indicating whether allowing the terminal device to extend an uplink transmission duration, during which uplink transmission is allowed, after expiry of a position validity duration, wherein the terminal device is allowed to extend the uplink transmission duration according to the at least one first indication if the at least one first indication allows the terminal device to extend the uplink transmission duration, until receiving from the network device a second indication indicating the terminal device to stop the uplink transmission duration, or the terminal device is allowed to extend the uplink transmission duration according to each of received multiple first indications if said each of the received multiple first indications allows the terminal device to extend the uplink transmission duration and is required to stop the uplink transmission duration when the uplink transmission duration extended according to said each of the first indications expires.

In a fifth aspect, disclosed is an apparatus for a terminal device. The apparatus for the terminal device may comprise: means for receiving from a network device, at least one first indication indicating whether allowing the terminal device to extend an uplink transmission duration, during which uplink transmission is allowed, after expiry of a position validity duration; and means for performing one of the following: extending the uplink transmission duration according to the at least one first indication if the at least one first indication allows the terminal device to extend the uplink transmission duration, until receiving from the network device a second indication indicating the terminal device to stop the uplink transmission duration, or extending the uplink transmission duration according to each of received multiple first indications if said each of the received multiple first indications allows the terminal device to extend the uplink transmission duration, and stopping the uplink transmission duration when the uplink transmission duration extended according to said each of the first indications expires.

In a sixth aspect, disclosed is an apparatus for a network device. The apparatus for the network device may comprise: means for transmitting to a terminal device, at least one first indication indicating whether allowing the terminal device to extend an uplink transmission duration, during which uplink transmission is allowed, after expiry of a position validity duration, wherein the terminal device is allowed to extend the uplink transmission duration according to the at least one first indication if the at least one first indication allows the terminal device to extend the uplink transmission duration, until receiving from the network device a second indication indicating the terminal device to stop the uplink transmission duration, or the terminal device is allowed to extend the uplink transmission duration according to each of received multiple first indications if said each of the received multiple first indications allows the terminal device to extend the uplink transmission duration and is required to stop the uplink transmission duration when the uplink transmission duration extended according to said each of the first indications expires.

In a seventh aspect, a computer readable medium is disclosed. The computer readable medium may comprise program instructions that, when executed by an apparatus for a terminal device, may cause the terminal device at least to: receive from a network device, at least one first indication indicating whether allowing the terminal device to extend an uplink transmission duration, during which uplink transmission is allowed, after expiry of a position validity duration; and perform one of the following: extending the uplink transmission duration according to the at least one first indication if the at least one first indication allows the terminal device to extend the uplink transmission duration, until receiving from the network device a second indication indicating the terminal device to stop the uplink transmission duration, or extending the uplink transmission duration according to each of received multiple first indications if said each of the received multiple first indications allows the terminal device to extend the uplink transmission duration, and stopping the uplink transmission duration when the uplink transmission duration extended according to said each of the first indications expires.

In an eighth aspect, a computer readable medium is disclosed. The computer readable medium may comprise program instructions that, when executed by an apparatus for a network device, cause the network device at least to: transmit to a terminal device, at least one first indication indicating whether allowing the terminal device to extend an uplink transmission duration, during which uplink transmission is allowed, after expiry of a position validity duration, wherein the terminal device is allowed to extend the uplink transmission duration according to the at least one first indication if the at least one first indication allows the terminal device to extend the uplink transmission duration, until receiving from the network device a second indication indicating the terminal device to stop the uplink transmission duration, or the terminal device is allowed to extend the uplink transmission duration according to each of received multiple first indications if said each of the received multiple first indications allows the terminal device to extend the uplink transmission duration and is required to stop the uplink transmission duration when the uplink transmission duration extended according to said each of the first indications expires.

Other features and advantages of the example embodiments of the present disclosure will also be apparent from the following description of specific embodiments when read in conjunction with the accompanying drawings, which illustrate, by way of example, the principles of example embodiments of the present disclosure.

### BRIEF DESCRIPTION OF THE DRAWINGS

Some example embodiments will now be described, by way of non-limiting examples, with reference to the accompanying drawings.

FIG. 1 shows an exemplary sequence diagram for the uplink transmission duration extension according to the example embodiments of the present disclosure.

FIG. 2 shows a flow chart illustrating an example method 200 for uplink transmission duration extension according to the example embodiments of the present disclosure.

FIG. 3 shows a flow chart illustrating an example method 300 for uplink transmission duration extension according to the example embodiments of the present disclosure.

FIG. 4 shows a block diagram illustrating an example device 400 for uplink transmission duration extension according to the example embodiments of the present disclosure.

FIG. 5 shows a block diagram illustrating an example device 500 for uplink transmission duration extension according to the example embodiments of the present disclosure.

FIG. 6 shows a block diagram illustrating an example apparatus 600 for uplink transmission duration extension according to the example embodiments of the present disclosure.

FIG. 7 shows a block diagram illustrating an example apparatus 700 for uplink transmission duration extension according to the example embodiments of the present disclosure.

Throughout the drawings, same or similar reference numbers indicate same or similar elements. A repetitive description on the same elements would be omitted.

### DETAILED DESCRIPTION

Herein below, some example embodiments are described in detail with reference to the accompanying drawings. The following description includes specific details for the purpose of providing a thorough understanding of various concepts. However, it will be apparent to those skilled in the art that these concepts may be practiced without these specific details. In some instances, well known circuits, techniques and components are shown in block diagram form to avoid obscuring the described concepts and features.

The network side may allow the UE to perform uplink transmission during an initial uplink transmission duration after expiry of the GNSS validity duration. The initial uplink transmission duration may be a duration X, which may be a remainder of a time alignment timer (TAT), e.g. timeAlignmentTimer as specified in the 3rd Generation Partnership Project (3GPP) Technical Specification (TS) 36.331, when the TAT is not infinity. Alternatively, the X may be equal to a configured value Y, when the TAT is infinity. The TAT may be used to control how long the medium access control (MAC) entity of the UE considers the network side e.g. the serving cell to be uplink time aligned.

Currently it is not clear whether the uplink transmission duration is allowed to be further extended, e.g., in a case where the UE is stationary and the uplink transmission duration can be further extended for uplink transmission. Moreover, there is no mechanism for the network side to indicate such an extension is allowed.

Example embodiments of the present disclosure provide a solution for uplink transmission duration extension in the NTN. According to the example embodiments of the present disclosure, the network side can configure whether the UE is allowed to perform uplink transmission after expiry of the GNSS validity duration for more than the initial uplink transmission duration. Furthermore, example embodiments of the present disclosure provide a mechanism on how the network side can signal such extension and how to stop the uplink transmission duration.

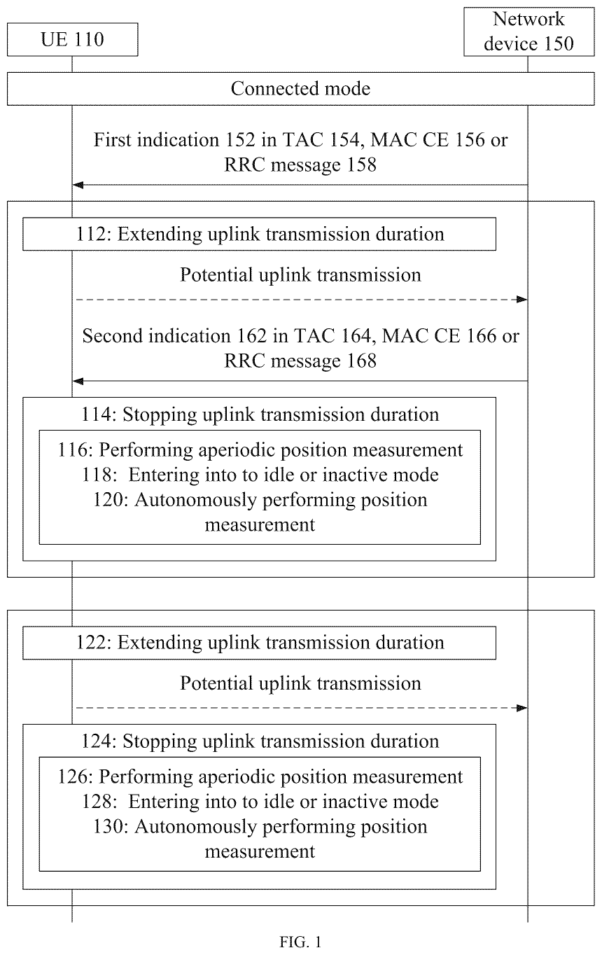

FIG. 1 shows an exemplary sequence diagram for the uplink transmission duration extension according to the example embodiments of the present disclosure. Referring to the FIG. 1, a UE 110 may represent any terminal device in the NTN and may be e.g. an internet of things (IoT) UE, an enhanced machine type communication (eMTC) UE, etc. A network device 150 may represent the network side serving the UE 110 in the NTN and may function as a base station (BS), e.g. an evolved node B (eNB), a next generation node B (gNB), etc.

Assuming that initially the UE 110 is in connected mode with the network device 150, the position validity duration, e.g. the GNSS validity duration also referred to as the remaining GNSS validity duration, of the UE 110 has expired, and the network device 150 has configured the UE 110 with an initial uplink transmission duration X, which may be a remainder of a timer for uplink time alignment e.g. the TAT or a configured value Y, i.e. X=Y, thus, when the position validity duration expires, the UE 110 may start the initial uplink transmission duration X, during which the UE 110 may perform uplink transmission and does not need to perform positioning measurements. A presumption may be that the UE 110 is not allowed to or is incapable of performing uplink transmissions and positioning measurements at the same time. The initial uplink transmission duration may have the configured value Y when the timer for uplink time alignment is infinite, for example.

Referring to the FIG. 1, the network device 150 may transmit to the UE 110 at least one first indication 152 indicating whether allowing the UE 110 to extend the uplink transmission duration, during which uplink transmission is allowed, after expiry of the position validity duration. The UE 110 may receive the at least one first indication 152 in the configuration of the initial uplink transmission duration X, alternatively or additionally, the UE 110 may receive the at least one first indication 152 during the uplink transmission duration, after receiving the configuration of the initial uplink transmission duration X.

If the at least one first indication 152 allows the UE 110 to extend the uplink transmission duration, the example embodiments of the present disclosure provide a solution for the UE 110 to extend and stop the uplink transmission duration. According to the example embodiments of the present disclosure, the UE 110 may extend the uplink transmission duration multiple times according to the at least one first indication 152 and stop the uplink transmission duration extension either when the uplink transmission duration extended multiple times according to said at least one first indication 152 expires or upon receiving from the network device a second indication 162 indicating the UE 110 to stop the uplink transmission duration.

In some embodiments, in an operation 112, the UE 110 may extend the uplink transmission duration according to the at least one first indication 152 if the at least one first indication 152 allows the UE 110 to extend the uplink transmission duration, until receiving from the network device 150 the second indication 162 indicating the UE 110 to stop the uplink transmission duration. In this case, the at least one first indication 152 may be a single first indication 152 that triggers the UE 110 to repeat the extension of the uplink transmission duration until receiving the second indication 162. The UE 110 may continue to extend the uplink transmission duration again and again if not receiving the second indication 162 before an ongoing extension is at an end. On the other hand, if receiving the second indication 162, the UE 110 stops the uplink transmission duration, even if the UE 110 is still in the initial uplink transmission duration X. The current uplink transmission duration may be stopped immediately upon receiving the second indication 162, or the current uplink transmission duration may be stopped at the end of the current uplink transmission duration, i.e. no further extensions shall be made. This embodiment provides for multiple extensions with low signaling overhead.

Alternatively, in some embodiments, in an operation 122, the UE 110 may extend the uplink transmission duration according to each of received multiple first indications 152 if said each of the received multiple first indications 152 allows the UE 110 to extend the uplink transmission duration, and in an operation 124 stop the uplink transmission duration when the uplink transmission duration extended according to said each of the first indications 152 expires. In this case, the network device 150 may indicate the extension individually for each new extension, and when the uplink transmission duration extended according to the first indications 152 expires, the UE 110 is required to stop the uplink transmission duration, even without the second indication 162. This embodiment provides for multiple extensions with increased reliability for stopping the extensions and not allowing the extensions to continue for too long.

In some embodiments, the at least one first indication 152 may indicate a number M, and in this case, the UE 110 may extend the uplink transmission duration by M times X. In this case, there may be a single first indication 152 and no second indication 162. This embodiment allows the multiple extensions with a very low signaling overhead. In this case the network device 150 may also stop the extension by transmitting the second indication 162, e.g. after M-1 uplink transmission durations. Thus, this embodiment may also prevent the extensions to run indefinitely.

In some embodiments, the at least one first indication 152 may indicate a factor K, and in this case, the UE 110 may extend the uplink transmission duration by X scaled by K.

In some embodiments, the at least one first indication 152 may indicate a duration Z, and in this case, the UE 110 may extend the uplink transmission duration by Z instead of X.

In some embodiments, if the at least one first indication 152 includes the number M, factor K and/or the duration Z, the at least one first indication 152 may implicitly indicate the UE 110 that the extension of the uplink transmission duration is allowed.

In some embodiments, if receiving the at least one first indication 152, in the operation 112/122, the UE 110 may restart/reset the uplink transmission duration when the current uplink transmission duration expires. For example, if the UE 110 receives the first indication 152 during the initial uplink transmission duration X, in the operation 112/122, the UE 110 restarts/resets the uplink transmission duration when the current initial uplink transmission duration X expires.

Alternatively, in some embodiments, the UE 110 may restart/reset the uplink transmission duration upon receiving the at least one first indication 152. For example, if the UE 110 receives the first indication 152 during the initial uplink transmission duration X, in the operation 112/122, the UE 110 restarts/resets the uplink transmission duration upon receiving the first indication 152, e.g. upon having processed the first indication 152, not waiting for the expiry of the current initial uplink transmission duration X.

In some embodiments, the at least one first indication 152 may be received in a MAC control element (CE) 156. For example, the at least one first indication 152 may be received in a GNSS MAC CE. Alternatively or additionally, the at least one first indication 152 may be received in a RRC message 158.

Alternatively or additionally, in some embodiments, the at least one first indication 152 may be received in a timing advance command (TAC) 154. If a legacy TAC is used for the purpose of extending the uplink transmission duration, e.g. the UE 110 restarts/resets the TAT and therefore the uplink transmission duration every time when receiving the TAC, this will prevent the network side from transmitting the TAC to correct the timing advance (TA) without also extending the uplink transmission duration. The following Table 1 shows the structure of the legacy TAC.

TABLE 1

| | | | | | | | | |
|---|---|---|---|---|---|---|---|---|
| Bit | 0 | 1 | 2 | 3 | 4 | 5 | 6 | 7 |

| | | |
|---|---|---|
| Value | TAG ID | TAC value |

As is shown in the Table 1, Bits 2 to 6 are used for correcting the TA, and Bits 0 to 1 are used for indicating the identifier (ID) of the timing advance group (TAG). Because the NTN deployments generally do not utilize carrier aggregation (CA) or dual connectivity (DC) where the TAGs are usually applied, so the Bits 0 and 1 may be used for extending the uplink transmission duration instead of the TAG ID. For example, the Bit 0 or 1 may be used as a flag to indicate whether the extension of the uplink transmission duration is allowed. Alternatively, one or more of Bits 2-7 may be used as the flag(s) if the NTN operation does not require the entire range of TAC values. Thus, the at least one first indication 152 may be received in the TAC 154 including the flag indicating whether the extension of the uplink transmission duration is allowed. If the flag indicates the extension of the uplink transmission duration is allowed, in the operation 112/122 the UE 110 may extend the uplink transmission duration. The TAC including the flag may also be received prior to the initial uplink transmission duration extension, i.e. when the GNSS validity duration is not expired. In this case, the TAC including the flag can be used to indicate whether the initial extension is allowed or not.

During the extended uplink transmission duration, the UE 110 may potentially perform the uplink transmission.

As is mentioned above, in some embodiments, the network device 150 may transmit to the UE 110 the second indication 162 to indicate the UE 110 to stop the uplink transmission duration. In some embodiments, the network device 150 may transmit the second indication 162 in a TAC 164. Similar to the TAC 154, the TAC 164 is the variant of the legacy TAC. For example, if one of the Bit 0 and the Bit 1 is used as the flag to indicate whether the extension of the uplink transmission duration is allowed, the same bit may be used as a flag indicating the extension of the uplink transmission duration is prohibited, i.e. to stop the uplink transmission duration, but with a flipped/opposite value, e.g. the bit=1 indicates extension is allowed/can continue while bit=0 indicates extension is not allowed (i.e. prohibited)/shall stop. Receiving the TAC 164 including the flag indicating the extension of the uplink transmission duration is prohibited, in an operation 114, the UE 110 stops the uplink transmission duration.

Alternatively or additionally, in some embodiments, the network device 150 may transmit the second indication 162 in a MAC CE 166, for example, the GNSS MAC CE. Alternatively or additionally, in some embodiments, the network device 150 may transmit the second indication 162 in a RRC message 168.

In some embodiments, the second indication 162 may explicitly indicate the UE 110 to stop the uplink transmission duration. Alternatively, in some embodiments, the second indication 162 may implicitly indicate the UE 110 to stop the uplink transmission duration. For example, the second indication 162 may trigger the UE 110 to perform an aperiodic position measurement, thus implicitly indicating the UE 110 to stop the uplink transmission duration. Thus, in an operation 116, the UE 110 may perform the aperiodic position measurement. For example, the second indication 162 may release the UE 110 to the idle or inactive mode, thus implicitly indicating the UE 110 to stop the uplink transmission duration. Thus, in an operation 118, the UE 110 may enter into the RRC idle or inactive mode. For example, the UE 110 may be configured to autonomously perform position measurement if receiving the second indication 162. Thus, the second indication 162 implicitly indicates the UE 110 to stop the uplink transmission duration, and in an operation 120, the UE 110 may autonomously perform the position measurement.

No matter the second indication 162 explicitly or implicitly indicates the UE 110 to stop the uplink transmission duration, if receiving the second indication 162, in some embodiments, the UE 110 stops the uplink transmission duration when the current uplink transmission duration expires, alternatively, in some embodiments, the UE 110 stops the uplink transmission duration upon receiving the second indication 162, e.g. upon having processed the second indication 162.

In a case where the UE 110 is required to stop the uplink transmission duration when the uplink transmission duration extended according to the first indication(s) 152 expires, after the uplink transmission duration expires, in some embodiments, in an operation 128, the UE 110 may enter into the RRC idle or inactive mode, alternatively, in some embodiments, in an operation 130, the UE 110 may autonomously perform the position measurement, alternatively, in some embodiments, the network device 150 may trigger the UE 110 to perform the aperiodic position measurement, and in this case the UE 110 to perform the aperiodic position measurement in an operation 126.

The example embodiments of the present disclosure enables the network side to dynamically control whether the uplink transmission is allowed, which may be especially useful in scenarios where the network side is not sure whether the UE may start to move. Moreover, according to the example embodiments of the present disclosure, if the UE has initially been indicated a short GNSS validity duration, but in reality is not moving i.e. a new GNSS measurement is not required, extending the duration where the uplink transmission is allowed is very useful.

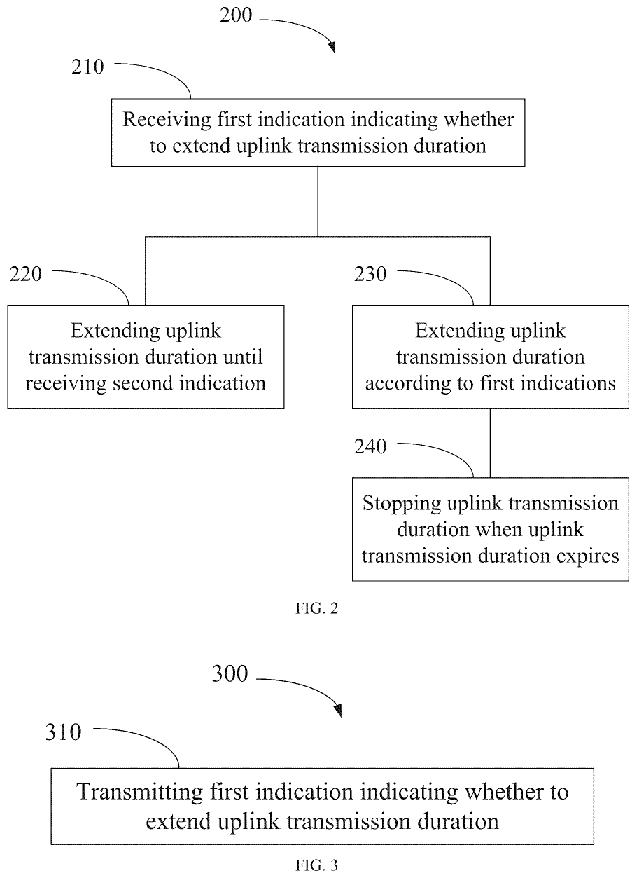

FIG. 2 shows a flow chart illustrating an example method 200 for uplink transmission duration extension according to the example embodiments of the present disclosure. The example method 200 may be performed for example by an apparatus for a terminal device such as the UE 110 above mentioned.

Referring to the FIG. 2, the example method 200 may comprise: an operation 210 of receiving from a network device, at least one first indication indicating whether allowing the terminal device to extend an uplink transmission duration, during which uplink transmission is allowed, after expiry of a position validity duration; and performing one of the following: an operation 220 of extending the uplink transmission duration according to the at least one first indication if the at least one first indication allows the terminal device to extend the uplink transmission duration, until receiving from the network device a second indication indicating the terminal device to stop the uplink transmission duration, or an operation 230 of extending the uplink transmission duration according to each of received multiple first indications if said each of the received multiple first indications allows the terminal device to extend the uplink transmission duration and an operation 240 of stopping the uplink transmission duration when the uplink transmission duration extended according to said each of the first indications expires.

Details of the operation 210 have been described in the above descriptions with respect to at least the first indication 152, and repetitive descriptions thereof are omitted here.

Details of the operation 220 have been described in the above descriptions with respect to at least the operations 112 and 114 and the second indication 162, and repetitive descriptions thereof are omitted here.

Details of the operation 230 have been described in the above descriptions with respect to at least the operation 122, and repetitive descriptions thereof are omitted here.

Details of the operation 240 have been described in the above descriptions with respect to at least the operation 124, and repetitive descriptions thereof are omitted here.

In some embodiments, an initial uplink transmission duration is a duration X which is a remainder of a timer for uplink time alignment or a configured value when the timer for uplink time alignment is infinite, the at least one first indication indicates a number M, and the example method 200 may comprise: an operation of extending the uplink transmission duration by M times X. The more details have been described in the above descriptions with respect to at least the operation 112/122, and repetitive descriptions thereof are omitted here.

In some embodiments, an initial uplink transmission duration is a duration X which is a remainder of a timer for uplink time alignment or a configured value when the timer for uplink time alignment is infinite, the at least one first indication indicates a factor K or a duration Z, and the example method 200 may comprise: an operation of extending the uplink transmission duration by X scaled by K or replaced by Z. The more details have been described in the above descriptions with respect to at least the operation 112/122, and repetitive descriptions thereof are omitted here.

In some embodiments, the example method 200 may comprise: an operation of restarting the uplink transmission duration when the current uplink transmission duration expires. The more details have been described in the above descriptions with respect to at least the operation 112/122, and repetitive descriptions thereof are omitted here.

In some embodiments, the example method 200 may comprise: an operation of restarting the uplink transmission duration upon receiving the at least one first indication. The more details have been described in the above descriptions with respect to at least the operation 112/122, and repetitive descriptions thereof are omitted here.

In some embodiments, the at least one first indication is received in a TAC including a flag indicating whether the extension of the uplink transmission duration is allowed. The more details have been described in the above descriptions with respect to at least the TAC 154, and repetitive descriptions thereof are omitted here.

In some embodiments, the at least one first indication is received in a MAC CE or a RRC message. The more details have been described in the above descriptions with respect to at least the MAC CE 156 and the RRC message 158, and repetitive descriptions thereof are omitted here.

In some embodiments, the second indication is received in a TAC including a flag indicating the extension of the uplink transmission duration is prohibited, a MAC CE or a RRC message. The more details have been described in the above descriptions with respect to at least the TAC 164, the MAC CE 166 and the RRC message 168, and repetitive descriptions thereof are omitted here.

In some embodiments, the second indication triggers the terminal device to perform an aperiodic position measurement. The more details have been described in the above descriptions with respect to at least the second indication 162 and operations 114 and 116, and repetitive descriptions thereof are omitted here.

In some embodiments, the second indication releases the terminal device to an idle or inactive mode. The more details have been described in the above descriptions with respect to at least the second indication 162 and operations 114 and 118, and repetitive descriptions thereof are omitted here.

In some embodiments, the example method 200 may comprise: an operation of autonomously performing position measurement if receiving the second indication. The more details have been described in the above descriptions with respect to at least the second indication 162 and operations 114 and 120, and repetitive descriptions thereof are omitted here.

In some embodiments, the example method 200 may comprise: an operation of stopping the uplink transmission duration when the current uplink transmission duration expires, if receiving the second indication. The more details have been described in the above descriptions with respect to at least the operation 114/124, and repetitive descriptions thereof are omitted here.

In some embodiments, the example method 200 may comprise: an operation of stopping the uplink transmission duration upon receiving the second indication. The more details have been described in the above descriptions with respect to at least the operation 114/124, and repetitive descriptions thereof are omitted here.

FIG. 3 shows a flow chart illustrating an example method 300 for uplink transmission duration extension according to the example embodiments of the present disclosure. The example method 300 may be performed for example by an apparatus for a network device such as the network device 150 above mentioned.

Referring to the FIG. 3, the example method 300 may comprise: an operation 310 of transmitting to a terminal device, at least one first indication indicating whether allowing the terminal device to extend an uplink transmission duration, during which uplink transmission is allowed, after expiry of a position validity duration, wherein the terminal device is allowed to extend the uplink transmission duration according to the at least one first indication if the at least one first indication allows the terminal device to extend the uplink transmission duration, until receiving from the network device a second indication indicating the terminal device to stop the uplink transmission duration, or the terminal device is allowed to extend the uplink transmission duration according to each of received multiple first indications if said each of the received multiple first indications allows the terminal device to extend the uplink transmission duration and is required to stop the uplink transmission duration when the uplink transmission duration extended according to said each of the first indications expires.

Details of the operation 310 have been described in the above descriptions with respect to at least at least the first indication 152, the second indication 162, the operation 112/122 and the operation 114/124, and repetitive descriptions thereof are omitted here.

In some embodiments, an initial uplink transmission duration is a duration X which is a remainder of a timer for uplink time alignment or a configured value when the timer for uplink time alignment is infinite, the at least one first indication indicates a number M, and the terminal device is allowed to extend the uplink transmission duration by M times X. The more details have been described in the above descriptions with respect to at least the operation 112/122, and repetitive descriptions thereof are omitted here.

In some embodiments, an initial uplink transmission duration is a duration X which is a remaining of a timer for uplink time alignment or a configured value when the timer for uplink time alignment is infinite, the at least one first indication indicates a factor K or a duration Z, and the terminal device is allowed to extend the uplink transmission duration by X scaled by K or replaced by Z. The more details have been described in the above descriptions with respect to at least the operation 112/122, and repetitive descriptions thereof are omitted here.

In some embodiments, the at least one first indication is transmitted in a timing advance command including a flag indicating whether the extension of the uplink transmission duration is allowed. The more details have been described in the above descriptions with respect to at least the TAC 154, and repetitive descriptions thereof are omitted here.

In some embodiments, the at least one first indication is transmitted in a MAC CE or a RRC message. The more details have been described in the above descriptions with respect to at least the MAC CE 156 and the RRC message 158, and repetitive descriptions thereof are omitted here.

In some embodiments, the second indication is transmitted in a timing advance command including a flag indicating the extension of the uplink transmission duration is prohibited, a MAC control element or a radio resource control message. The more details have been described in the above descriptions with respect to at least the TAC 164, the MAC CE 166 and the RRC message 168, and repetitive descriptions thereof are omitted here.

In some embodiments, the second indication triggers the terminal device to perform an aperiodic position measurement. The more details have been described in the above descriptions with respect to at least the second indication 162 and operations 114 and 116, and repetitive descriptions thereof are omitted here.

In some embodiments, the second indication releases the terminal device to an idle or inactive mode. The more details have been described in the above descriptions with respect to at least the second indication 162 and operations 114 and 118, and repetitive descriptions thereof are omitted here.

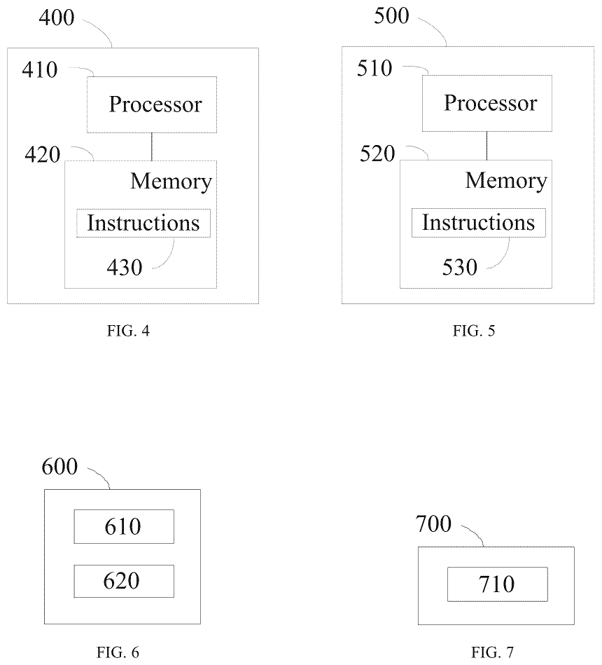

FIG. 4 shows a block diagram illustrating an example device 400 for uplink transmission duration extension according to the example embodiments of the present disclosure. The device, for example, may be at least part of an apparatus for a terminal device such as the UE 110 in the above examples.

As shown in the FIG. 4, the example device 400 may include at least one processor 410 and at least one memory 420 that may store instructions 430. The instructions 430, when executed by the at least one processor 410, may cause the device 400 at least to perform the example method 200 described above.

In various example embodiments, the at least one processor 410 in the example device 400 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 410 may also include at least one other circuitry or element not shown in the FIG. 4.

In various example embodiments, the at least one memory 420 in the example device 400 may include at least one storage medium in various forms, such as a transitory memory and/or a non-transitory memory. The transitory memory may include, but not limited to, for example, a random-access memory (RAM), a cache, and so on. The non-transitory memory may include, but not limited to, for example, a read only memory (ROM), a hard disk, a flash memory, and so on. The term “non-transitory,” as used herein, is a limitation of the medium itself (i.e., tangible, not a signal) as opposed to a limitation on data storage persistency (e.g., RAM vs. ROM). Further, the at least memory 420 may include, but are not limited to, an electric, a magnetic, an optical, an electromagnetic, an infrared, or a semiconductor system, apparatus, or device or any combination of the above.

Further, in various example embodiments, the example device 400 may also include at least one other circuitry, element, and interface, for example at least one I/O interface, at least one antenna element, and the like.

In various example embodiments, the circuitries, parts, elements, and interfaces in the example device 400, including the at least one processor 410 and the at least one memory 420, may be coupled together via any suitable connections including, but not limited to, buses, crossbars, wiring and/or wireless lines, in any suitable ways, for example electrically, magnetically, optically, electromagnetically, and the like.

It is appreciated that the structure of the device on the side of the UE 110 is not limited to the above example device 400.

FIG. 5 shows a block diagram illustrating an example device 500 for uplink transmission duration extension according to the example embodiments of the present disclosure. The device, for example, may be at least part of an apparatus for a network device such as the network device 150 in the above examples.

As shown in the FIG. 5, the example device 500 may include at least one processor 510 and at least one memory 520 that may store instructions 530. The instructions 530, when executed by the at least one processor 510, may cause the device 500 at least to perform the example method 300 described above.

In various example embodiments, the at least one processor 510 in the example device 500 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 510 may also include at least one other circuitry or element not shown in the FIG. 5.

In various example embodiments, the at least one memory 520 in the example device 500 may include at least one storage medium in various forms, such as a transitory memory and/or a non-transitory memory. The transitory memory may include, but not limited to, for example, a random-access memory (RAM), a cache, and so on. The non-transitory memory may include, but not limited to, for example, a read only memory (ROM), a hard disk, a flash memory, and so on. The term “non-transitory,” as used herein, is a limitation of the medium itself (i.e., tangible, not a signal) as opposed to a limitation on data storage persistency (e.g., RAM vs. ROM). Further, the at least memory 520 may include, but are not limited to, an electric, a magnetic, an optical, an electromagnetic, an infrared, or a semiconductor system, apparatus, or device or any combination of the above.

Further, in various example embodiments, the example device 500 may also include at least one other circuitry, element, and interface, for example at least one I/O interface, at least one antenna element, and the like.

In various example embodiments, the circuitries, parts, elements, and interfaces in the example device 500, including the at least one processor 510 and the at least one memory 520, may be coupled together via any suitable connections including, but not limited to, buses, crossbars, wiring and/or wireless lines, in any suitable ways, for example electrically, magnetically, optically, electromagnetically, and the like.

It is appreciated that the structure of the device on the side of the network device 150 is not limited to the above example device 500.

FIG. 6 shows a block diagram illustrating an example apparatus 600 for uplink transmission duration extension according to the example embodiments of the present disclosure. The apparatus, for example, may be at least part of a terminal device such as the UE 110 in the above examples.

As shown in the FIG. 6, the example apparatus 600 may comprise: means 610 for receiving from a network device, at least one first indication indicating whether allowing the terminal device to extend an uplink transmission duration, during which uplink transmission is allowed, after expiry of a position validity duration; and means 620 for performing one of the following: extending the uplink transmission duration according to the at least one first indication if the at least one first indication allows the terminal device to extend the uplink transmission duration, until receiving from the network device a second indication indicating the terminal device to stop the uplink transmission duration, or extending the uplink transmission duration according to each of received multiple first indications if said each of the received multiple first indications allows the terminal device to extend the uplink transmission duration and stopping the uplink transmission duration when the uplink transmission duration extended according to said each of the first indications expires.

In some embodiments, an initial uplink transmission duration is a duration X which is a remainder of a timer for uplink time alignment or a configured value when the timer for uplink time alignment is infinite, the at least one first indication indicates a number M, and the apparatus 600 may comprise means for extending the uplink transmission duration by M times X.

In some embodiments, an initial uplink transmission duration is a duration X which is a remainder of a timer for uplink time alignment or a configured value when the timer for uplink time alignment is infinite, the at least one first indication indicates a factor K or a duration Z, and the apparatus 600 may comprise means for extending the uplink transmission duration by X scaled by K or replaced by Z.

In some embodiments, the apparatus 600 may comprise means for restarting the uplink transmission duration when the current uplink transmission duration expires.

In some embodiments, the apparatus 600 may comprise means for restarting the uplink transmission duration upon receiving the at least one first indication.

In some embodiments, the at least one first indication is received in a TAC including a flag indicating whether the extension of the uplink transmission duration is allowed.

In some embodiments, the at least one first indication is received in a MAC CE or a RRC message.

In some embodiments, the second indication is received in a TAC including a flag indicating the extension of the uplink transmission duration is prohibited, a MAC CE or a RRC message.

In some embodiments, the second indication triggers the terminal device to perform an aperiodic position measurement.

In some embodiments, the second indication releases the terminal device to an idle or inactive mode.

In some embodiments, the apparatus 600 may comprise means for autonomously performing position measurement if receiving the second indication.

In some embodiments, the apparatus 600 may comprise means for stopping the uplink transmission duration when the current uplink transmission duration expires, if receiving the second indication.

In some embodiments, the apparatus 600 may comprise means for stopping the uplink transmission duration upon receiving the second indication.

In some example embodiments, examples of means in the example apparatus 600 may include circuitries. For example, an example of means 610 may include a circuitry configured to perform the operation 210 of the example method 200, and an example of means 620 may include a circuitry configured to perform the operation 220 or the operations 230 and 240 of the example method 200.

The example apparatus 600 may further include means comprising circuitry configured to perform the example method 200. In some example embodiments, examples of means may also include software modules and any other suitable function entities.

FIG. 7 shows a block diagram illustrating an example apparatus 700 for uplink transmission duration extension according to the example embodiments of the present disclosure. The apparatus, for example, may be at least part of a network device such as the network device 150 in the above examples.

As shown in the FIG. 7, the example apparatus 700 may comprise: means 710 for transmitting to a terminal device, at least one first indication indicating whether allowing the terminal device to extend an uplink transmission duration, during which uplink transmission is allowed, after expiry of a position validity duration, wherein the terminal device is allowed to extend the uplink transmission duration according to the at least one first indication if the at least one first indication allows the terminal device to extend the uplink transmission duration, until receiving from the network device a second indication indicating the terminal device to stop the uplink transmission duration, or the terminal device is allowed to extend the uplink transmission duration according to each of received multiple first indications if said each of the received multiple first indications allows the terminal device to extend the uplink transmission duration and is required to stop the uplink transmission duration when the uplink transmission duration extended according to said each of the first indications expires.

In some embodiments, an initial uplink transmission duration is a duration X which is a remainder of a timer for uplink time alignment or a configured value when the timer for uplink time alignment is infinite, the at least one first indication indicates a number M, and the terminal device is allowed to extend the uplink transmission duration by M times X.

In some embodiments, an initial uplink transmission duration is a duration X which is a remaining of a timer for uplink time alignment or a configured value when the timer for uplink time alignment is infinite, the at least one first indication indicates a factor K or a duration Z, and the terminal device is allowed to extend the uplink transmission duration by X scaled by K or replaced by Z.

In some embodiments, the at least one first indication is transmitted in a timing advance command including a flag indicating whether the extension of the uplink transmission duration is allowed.

In some embodiments, the at least one first indication is transmitted in a MAC CE or a RRC message.

In some embodiments, the second indication is transmitted in a timing advance command including a flag indicating the extension of the uplink transmission duration is prohibited, a MAC control element or a radio resource control message.

In some embodiments, the second indication triggers the terminal device to perform an aperiodic position measurement.

In some embodiments, the second indication releases the terminal device to an idle or inactive mode.

In some example embodiments, examples of means in the example apparatus 700 may include circuitries. For example, an example of means 710 may include a circuitry configured to perform the operation 310 of the example method 300.

The example apparatus 700 may further include means comprising circuitry configured to perform the example method 300. In some example embodiments, examples of means may also include software modules and any other suitable function entities.

The example embodiments of the present disclosure also provide a computer readable medium comprising program instructions that, when executed by an apparatus for a terminal device such as the UE 110 in the above examples, may cause the terminal device at least to: receive from a network device, at least one first indication indicating whether allowing the terminal device to extend an uplink transmission duration, during which uplink transmission is allowed, after expiry of a position validity duration; and perform one of the following: extending the uplink transmission duration according to the at least one first indication if the at least one first indication allows the terminal device to extend the uplink transmission duration, until receiving from the network device a second indication indicating the terminal device to stop the uplink transmission duration, or extending the uplink transmission duration according to each of received multiple first indications if said each of the received multiple first indications allows the terminal device to extend the uplink transmission duration and stopping the uplink transmission duration when the uplink transmission duration extended according to said each of the first indications expires.

In some embodiments, an initial uplink transmission duration is a duration X which is a remainder of a timer for uplink time alignment or a configured value when the timer for uplink time alignment is infinite, the at least one first indication indicates a number M, and the computer readable medium may include instructions that, when executed by the apparatus, may cause the terminal device to: extend the uplink transmission duration by M times X.

In some embodiments, an initial uplink transmission duration is a duration X which is a remainder of a timer for uplink time alignment or a configured value when the timer for uplink time alignment is infinite, the at least one first indication indicates a factor K or a duration Z, and the computer readable medium may include instructions that, when executed by the apparatus, may cause the terminal device to: extend the uplink transmission duration by X scaled by K or replaced by Z.

In some embodiments, the computer readable medium may include instructions that, when executed by the apparatus, may cause the terminal device to: restart the uplink transmission duration when the current uplink transmission duration expires.

In some embodiments, the computer readable medium may include instructions that, when executed by the apparatus, may cause the terminal device to: restart the uplink transmission duration upon receiving the at least one first indication.

In some embodiments, the at least one first indication is received in a TAC including a flag indicating whether the extension of the uplink transmission duration is allowed.

In some embodiments, the at least one first indication is received in a MAC CE or a RRC message.

In some embodiments, the second indication is received in a TAC including a flag indicating the extension of the uplink transmission duration is prohibited, a MAC CE or a RRC message.

In some embodiments, the second indication triggers the terminal device to perform an aperiodic position measurement.

In some embodiments, the second indication releases the terminal device to an idle or inactive mode.

In some embodiments, the computer readable medium may include instructions that, when executed by the apparatus, may cause the terminal device to: autonomously perform position measurement if receiving the second indication.

In some embodiments, the computer readable medium may include instructions that, when executed by the apparatus, may cause the terminal device to: stop the uplink transmission duration when the current uplink transmission duration expires, if receiving the second indication.

In some embodiments, the computer readable medium may include instructions that, when executed by the apparatus, may cause the terminal device to: stop the uplink transmission duration upon receiving the second indication.

The example embodiments of the present disclosure also provide a computer readable medium comprising program instructions that, when executed by an apparatus for a network device such as the network device 150 in the above examples, may cause the network device at least to: transmit to a terminal device, at least one first indication indicating whether allowing the terminal device to extend an uplink transmission duration, during which uplink transmission is allowed, after expiry of a position validity duration, wherein the terminal device is allowed to extend the uplink transmission duration according to the at least one first indication if the at least one first indication allows the terminal device to extend the uplink transmission duration, until receiving from the network device a second indication indicating the terminal device to stop the uplink transmission duration, or the terminal device is allowed to extend the uplink transmission duration according to each of received multiple first indications if said each of the received multiple first indications allows the terminal device to extend the uplink transmission duration and is required to stop the uplink transmission duration when the uplink transmission duration extended according to said each of the first indications expires.

In some embodiments, an initial uplink transmission duration is a duration X which is a remainder of a timer for uplink time alignment or a configured value when the timer for uplink time alignment is infinite, the at least one first indication indicates a number M, and the terminal device is allowed to extend the uplink transmission duration by M times X.

In some embodiments, an initial uplink transmission duration is a duration X which is a remaining of a timer for uplink time alignment or a configured value when the timer for uplink time alignment is infinite, the at least one first indication indicates a factor K or a duration Z, and the terminal device is allowed to extend the uplink transmission duration by X scaled by K or replaced by Z.

In some embodiments, the at least one first indication is transmitted in a timing advance command including a flag indicating whether the extension of the uplink transmission duration is allowed.

In some embodiments, the at least one first indication is transmitted in a MAC CE or a RRC message.

In some embodiments, the second indication is transmitted in a timing advance command including a flag indicating the extension of the uplink transmission duration is prohibited, a MAC control element or a radio resource control message.

In some embodiments, the second indication triggers the terminal device to perform an aperiodic position measurement.

In some embodiments, the second indication releases the terminal device to an idle or inactive mode.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the above description, the terms “terminal device”, “communication device”, “terminal”, “user equipment” and “UE” may be used interchangeably.

The term “circuitry” throughout this disclosure may refer to one or more or all of the following: (a) hardware-only circuit implementations (such as implementations in only analog and/or digital circuitry); (b) combinations of hardware circuits and software, such as (as applicable) (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions); and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to one or all uses of this term in this disclosure, including in any claims. As a further example, as used in this disclosure, the term circuitry also covers an implementation of merely a hardware circuit or processor (or multiple processors) or portion of a hardware circuit or processor and its (or their) accompanying software and/or firmware. The term circuitry also covers, for example and if applicable to the claim element, a baseband integrated circuit or processor integrated circuit for a mobile device or a similar integrated circuit in server, a cellular network device, or other computing or network device.

Another example embodiment may relate to computer program codes or instructions which may cause an apparatus to perform at least respective methods described above. Another example embodiment may be related to a computer readable medium having such computer program codes or instructions stored thereon. In some embodiments, such a computer readable medium may include at least one storage medium in various forms such as a volatile memory and/or a non-volatile memory. The volatile memory may include, but not limited to, for example, a RAM, a cache, and so on. The non-volatile memory may include, but not limited to, a ROM, a hard disk, a flash memory, and so on. The non-volatile memory may also include, but are not limited to, an electric, a magnetic, an optical, an electromagnetic, an infrared, or a semiconductor system, apparatus, or device or any combination of the above.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

As used herein, the term “determine/determining” (and grammatical variants thereof) can include, not least: calculating, computing, processing, deriving, measuring, investigating, looking up (for example, looking up in a table, a database or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

While some embodiments have been described, these embodiments have been presented by way of example, and are not intended to limit the scope of the disclosure. Indeed, the apparatus, methods, and systems described herein may be embodied in a variety of other forms; furthermore, various omissions, substitutions and changes in the form of the methods and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. At least one of these blocks may be implemented in a variety of different ways. The order of these blocks may also be changed. Any suitable combination of the elements and actions of the some embodiments described above can be combined to provide further embodiments. The accompanying claims and their equivalents are intended to cover such forms or modifications as would fall within the scope and spirit of the disclosure.

Abbreviations used in the description and/or in the figures are defined as follows:
3GPP TS 3rd Generation Partnership Project Technical Specification
BS base station
CA carrier aggregation
CE control element
DC dual connectivity
eMTC enhanced machine type communication
eNB evolved node B
gNB the next generation node B
GNSS global navigation satellite system
ID identifier
IoT internet of things
MAC medium access control
NTN non-terrestrial network
RRC radio resource control
TA timing advance
TAC timing advance command
TAG timing advance group
TAT time alignment timer
UE user equipment

What is claimed is:

1. An apparatus for a terminal device, comprising:
at least one processor; and
at least one memory storing instructions that, when executed by the at least one processor, cause the terminal device occasion at least to:
receive from a network device, at least one first indication indicating whether allowing the terminal device to extend an uplink transmission duration, during which uplink transmission is allowed, after expiry of a position validity duration; and
perform one of the following:
extending the uplink transmission duration according to the at least one first indication if the at least one first indication allows the terminal device to extend the uplink transmission duration, until receiving from the network device a second indication indicating the terminal device to stop the uplink transmission duration, or
extending the uplink transmission duration according to each of received multiple first indications if said each of the received multiple first indications allows the terminal device to extend the uplink transmission duration, and stopping the uplink transmission duration when the uplink transmission duration extended according to said each of the first indications expires.

2. The apparatus of claim 1, wherein an initial uplink transmission duration is a duration X which is a remainder of a timer for uplink time alignment or a configured value when the timer for uplink time alignment is infinite, the at least one first indication indicates a number M, and the apparatus is configured to:
extend the uplink transmission duration by M times X.

3. The apparatus of claim 1, wherein an initial uplink transmission duration is a duration X which is a remainder of a timer for uplink time alignment or a configured value when the timer for uplink time alignment is infinite, the at least one first indication indicates a duration Z, and the apparatus is configured to:
extend the uplink transmission duration by X replaced by Z.

4. The apparatus of claim 1, wherein the apparatus is configured to:
restart the uplink transmission duration when the current uplink transmission duration expires.

5. The apparatus of claim 1, wherein the apparatus is configured to:
restart the uplink transmission duration upon receiving the at least one first indication.

6. The apparatus of claim 1, wherein the at least one first indication is received in a timing advance command including a flag indicating whether the extension of the uplink transmission duration is allowed.

7. The apparatus of claim 1, wherein the at least one first indication is received in a radio resource control message.

8. The apparatus of claim 1, wherein the second indication is received in a MAC control element.

9. The apparatus of claim 1, wherein the second indication triggers the terminal device to perform an aperiodic position measurement.

10. The apparatus of claim 1, wherein the apparatus is configured to:
stop the uplink transmission duration upon receiving the second indication.

11. An apparatus for a network device, comprising:
at least one processor; and
at least one memory storing instructions that, when executed by the at least one processor, cause the network device at least to:
transmit to a terminal device, at least one first indication indicating whether allowing the terminal device to extend an uplink transmission duration, during which uplink transmission is allowed, after expiry of a position validity duration, wherein
the terminal device is allowed to extend the uplink transmission duration according to the at least one first indication if the at least one first indication allows the terminal device to extend the uplink transmission duration, until receiving from the network device a second indication indicating the terminal device to stop the uplink transmission duration, or
the terminal device is allowed to extend the uplink transmission duration according to each of received multiple first indications if said each of the received multiple first indications allows the terminal device to extend the uplink transmission duration and is required to stop the uplink transmission duration when the uplink transmission duration extended according to said each of the first indications expires.

12. The apparatus of claim 11, wherein an initial uplink transmission duration is a duration X which is a remainder of a timer for uplink time alignment or a configured value when the timer for uplink time alignment is infinite, the at least one first indication indicates a number M, and the terminal device is allowed to extend the uplink transmission duration by M times X.

13. The apparatus of claim 12, wherein an initial uplink transmission duration is a duration X which is a remaining of a timer for uplink time alignment or a configured value when the timer for uplink time alignment is infinite, the at least one first indication indicates a duration Z, and the terminal device is allowed to extend the uplink transmission duration by X replaced by Z.

14. The apparatus of claim 11, wherein the second indication is transmitted in a MAC control element.

15. The apparatus of claim 11, wherein the second indication triggers the terminal device to perform an aperiodic position measurement.

16. A method performed by an apparatus for a terminal device, comprising:
receiving from a network device, at least one first indication indicating whether allowing the terminal device to extend an uplink transmission duration, during which uplink transmission is allowed, after expiry of a position validity duration; and
performing one of the following:
extending the uplink transmission duration according to the at least one first indication if the at least one first indication allows the terminal device to extend the uplink transmission duration, until receiving from the network device a second indication indicating the terminal device to stop the uplink transmission duration, or
extending the uplink transmission duration according to each of received multiple first indications if said each of the received multiple first indications allows the terminal device to extend the uplink transmission duration, and stopping the uplink transmission duration when the uplink transmission duration extended according to said each of the first indications expires.

17. The method of claim 16, wherein an initial uplink transmission duration is a duration X which is a remainder of a timer for uplink time alignment or a configured value when the timer for uplink time alignment is infinite, the at least one first indication indicates a duration Z, and the method comprises:
extending the uplink transmission duration by X replaced by Z.

18. The method of claim 16, comprising:
restarting the uplink transmission duration upon receiving the at least one first indication.

19. The method of claim 16, wherein the at least one first indication is received in a radio resource control message.

20. The method of claim 16, comprising:
stopping the uplink transmission duration upon receiving the second indication.
